(19) United States
(12) Patent Application Publication
(10) Pub. No.: US 2024/0005519 A1
(43) Pub. Date: Jan. 4, 2024

(54) SYSTEM AND METHOD FOR DETECTION AND MONITORING OF IMPACT

(71) Applicant: Alpha Fiber, Inc., San Diego, CA (US)

(72) Inventors: Arash Adami, San Diego, CA (US); Derek Rollend, San Diego, CA (US)

(21) Appl. No.: 18/039,951

(22) PCT Filed: Dec. 6, 2021
(86) PCT No.: PCT/US2021/062075

§ 371 Date: Jun. 1, 2023

Related U.S. Application Data
(60) Provisional application No. 63/121,889, filed on Dec. 5, 2020.

(51) Int. Cl. G06T 7/207; G06T 7/246

(52) U.S. Cl. CPC G06T 7/207; G06T 7/246; G06T 2207/20081; G06T 2207/20084; G06T 2207/30196

(57) ABSTRACT

A system and method for monitoring physical impact on a body include at least one camera configured to collect high frame rate video images having a plurality of image frames of the body within a defined area. A computer processor receives the video images and executes a learning algorithm for tracking one or more points of the body, then calculates a force applied to the one or more points. The calculated force is compared to an impact threshold that corresponds to risk associated with traumatic brain injury (TBI) or other injury.

### RELATED APPLICATIONS

This application claims the benefit of the priority of U.S. Application No. 63/121,889, filed Dec. 5, 2020, which is incorporated herein by reference in its entirety.

### FIELD OF THE INVENTION

The present invention relates to a computer vision system and method for visually detecting and monitoring impact on a body or object.

### BACKGROUND

Concussion or mild traumatic brain injury (TBI) is a public health crisis that affects a large number of people—approaching 4 million injuries—every year. Countless other TBIs go unseen and undiagnosed (Jackson and Starling, 2019). A concussion can be caused by an abrupt contact or blow to the head or body, causing the head to accelerate/decelerate rapidly potentially impacting the brain's structural integrity and function. This head motion can be measured using accelerators, similar to ones used in modern consumer electronic devices. such as smart phones, tablets, and laptop computers.

Each year, worldwide, there are more than 60 million new cases of traumatic TBI. Road traffic crashes and falls are the primary causes of TBI, however, a significant number of these injuries arise from participation in athletic activities. TBI is especially common in children and young adults and is associated with long-term mortality and morbidity. Juveniles seem to be at increased risk of developing cerebral edema after TBI partly due to higher water content and developmental differences in the brain's response to injury. For example, in 2017, an estimated 2.5 million high school students reported having at least one concussion related to sports or physical activity during the year preceding the 2017 national Youth Risk Behavior Study (YRBS), and an estimated 1.0 million students reported having two or more concussions during the same time frame (U.S. CDC, Morbidity and Mortality Weekly Report, L. DePadilla, et al., Jun. 22, 2018; 67(24); 682-685). Most strikingly, the vast majority of high-impact sports and many military training exercises, approaching 80%, do not utilize protective helmets or sensors. Consequently, concussions can go undiagnosed for days, if detected at all.

When utilized, current concussion detection technologies have aided in the diagnosis of concussions but are limited in multiple ways: they are generally time insensitive, costly, require special equipment and/or wearing of a detector/sensor equipped with an accelerometer. Blood biomarkers, such as proteins associated with cell injury and brain antigen-targeting autoantibodies, and clinical imaging methods (MRI, CT, etc.), including diffusion tensor imaging (DTI) and density imaging, have been shown to help in the diagnosis of cognitive deficits, but can be expensive, requiring time, highly specialized imaging equipment and analysis software, and interpretation by trained medical professionals. Conventional MRI often cannot differentiate mTBIs from normal cases (Tong et al 2004). Behavior protocols have continued to be developed with new hardware and software ranging from oculomotor tracking to memory and motor tasks on a tablet, but are subject to end-user biases and errors, and therefore are not objective measures.

Motion detection techniques using wearables such as mouthguards, helmets, or headbands equipped with an accelerator and/or gyroscope, powered by a lithium battery, have been developed but suffer from multiple limitations, the first of which is cost: the athletes generally must purchase them, and maintenance and replacement costs can become prohibitive. These expenses further expand wealth inequality in sports participation. While athletes from more affluent families can afford such safety measures, lower income participants cannot afford the average $1000 sensors (Adami 2018) and are put at greater risk. Another limitation is the generally poor accuracy of the sensors, which is below industry standards (±3%). Finally, compliance is a factor—some athletes find the devices cumbersome or uncomfortable and may be develop a habit of conveniently “forgetting” to use the device during important contests.

There is a growing appreciation for the need of quantifiable and objective head impact monitoring and logging. Although headgear sensors are being developed to monitor impacts, at least 70% of athletes involved in high-risk sports decline to wear non-mandatory headgear (e.g., soccer, rugby) and will be left without monitoring. One approach to monitoring athletes for potential concussion is described in U.S. Pat. No. 10,115,200 of Sicking et al., which is incorporated herein by reference. Sicking et al.'s method analyzes sports impact using video cameras that track the players helmets, measuring velocities, acceleration and changes in orientation of identifiable points on the helmets. While this approach may work for sports in which the same type of helmets are worn by all players, it is of limited use since not all sports require helmets to be worn. Beyond this, even in sports where helmets are regularly worn, they will not prevent all concussions (especially those caused by collisions, which is, for example, the main cause of concussion in lacrosse), but they may reduce symptom duration or severity of brain trauma.

In view of the lack of broad access to accessible and accurate wearable sensors, the standard-of-care has remained subjective observation by trained or untrained sideline observers. Delayed or no treatment for concussed individuals can lead to long-term behavioral and neurological deficits. Traumatic brain injury and repeated mild traumatic brain injury have been linked to permanent impairments and neurodegenerative disease, including chronic traumatic encephalopathy Accordingly, time-sensitive concussion detection for athletes would fulfill a longstanding unmet need for not only sports with secure helmets (football, lacrosse, hockey) and mouthguards (rugby), but also other contact or semi-contact sports (e.g., soccer, basketball, boxing, wrestling, karate, and other martial arts).

### BRIEF SUMMARY

The inventive system and method employ a combination of computer vision, the processing power of commercially available hardware, machine-learning algorithms, and supporting software. In an embodiment for use in monitoring activity participants, computer vision is used to provide objective visualization, replacing the current standard of visual observation by a trained concussion professional, which is prone to human bias/error. The net result through this approach is more accurate and consistent measures. The inventive solution is also less labor-intensive and more cost-effective per participant. The inventive solution can be configured to fit virtually any size sports-play area and has the potential to positively impact countless athletes globally. In particular, a camera-based concussion detection system that automatically calculates the force exerted against a participant in real-time, low cost, scalable and objective manner, yielding more consistent and accurate results. Computer vision (CV) is a mature technology that is currently applied in many different industries including sports, transportation, and surveillance. CV is actively being utilized in an increasing number of everyday applications. Rapid advances in camera technology and increasing network bandwidths provide tools for generating and rapidly analyzing the data. Preliminary work has demonstrated the ability to accurately track multiple heads in a real-world boxing setting and controlled testing using a crash dummy lab has verified the preliminary force calculations. In one implementation the inventive approach is directed to increasing the accuracy achieved with modern off-the-shelf deep learning neural networks such as the YOLO (You Only Look Once) real-time object detection algorithm, which is used in some autonomous vehicle systems.

The inventive system and method are directed toward a computer vision-based motion detection, object tracking, and proprietary force calculations. While the initial focus is on concussion detection and other impacts on the living body, the principles of the invention are also applicable to more general uses of impact detection, for example, vehicles and physical objects that can degrade with time and repetitive impacts so as to warrant monitoring for force and frequency of impacts.

The inventive approach combines traditional computer vision with modern deep learning algorithms, with the goal of replicating the effectiveness of subjective observation to detect significant head impacts in sports. In the initial study, mixed martial arts and boxing are studied.

In one aspect of the invention, a system for monitoring physical impact on a body includes at least one camera configured to collect video images comprising a plurality of image frames of the body within a defined area, the video images comprising a sequence of high resolution data at a high frame rate; a computer processor configured to receive the video images and execute a learning algorithm for tracking one or more points of the body and calculate a force applied to the one or more points; and a high-speed interface configured to communicate the video images to the computer processor. In some embodiments, the body is a human body and the one or more points are associated with a head.

The defined area may be a field of play, and the at least one camera may be a plurality of cameras where each camera is positioned to at least partially surround the field of play.

In some embodiments, the high frame rate is on the order of 120 fps or more. The high-speed interface may be a 10 GigE or faster interface.

The learning algorithm may be a neural network, and may be YOLO.

The computer processor may be further configured to generate an alert message to a user interface when the calculated force exceeds a predetermined threshold. In some implementations, the predetermined threshold may correspond to one or both of a high risk impact and a low limit impact threshold. A memory may be provided in communication with the computer processor for recording and cataloging video images and impact data corresponding thereto.

In another aspect, a method for monitoring physical impact on a body includes: collecting video images comprising a plurality of image frames of the body within a defined area, the video images comprising a sequence of high resolution data at a high frame rate; receiving the video images within a computer processor and executing a learning algorithm for tracking one or more points of the body within the video images; calculating a force applied to the one or more points; and comparing the calculated force to a predetermined threshold corresponding to an impact associated with a potential injury risk. In some embodiments, the body is a human body and the one or more points are associated with a head.

The defined area may be a field of play, and the at least one camera may be a plurality of cameras where each camera is positioned to at least partially surround the field of play.

In some embodiments, the high frame rate is on the order of 120 fps or more. The high-speed interface may be a 10 GigE or faster interface.

The learning algorithm may be a neural network, and may be YOLO.

The computer processor may be further configured to generate an alert message to a user interface when the calculated force exceeds a predetermined threshold. In some implementations, the predetermined threshold may correspond to one or both of a high risk impact and a low limit impact threshold. A memory may be provided in communication with the computer processor for recording and cataloging video images and impact data corresponding thereto.

This inventive approach utilizes a multi-camera system for the objective monitoring of potential concussive events. A key goal of the inventive approach is to provide more consistent and accurate concussion diagnosis. Two major components of the system are the cameras with high frame rate and resolution, which are needed to generate sufficient data to measure forces exerted on the head, and the processing hardware/software to analyze the video data at a sufficiently rapid speed to generate results as close to real-time as possible. This can be achieved without requiring any sensors or special equipment physically on the athlete.

### BRIEF DESCRIPTION OF THE DRAWINGS

FIG. 1 is a diagrammatic view of the basic components of an exemplary system for implementing an embodiment of the inventive method.

FIG. 2 is a high level flow diagram showing steps of an embodiment of the inventive method and system.

FIG. 3 is a flow diagram showing steps of an analysis sequence according to an embodiment of the inventive method and system.

FIGS. 4A and 4B are photographs of sample training images with stick figures (wire frame) and bounding rectangles, respectively, superimposed over the images;

FIG. 4C is a photograph of a face showing fiducial points and reference lines superimposed over the image.

FIG. 5 is a block diagram summarizing key components of an embodiment of the inventive system.

FIG. 6 is a sequence of still frame images taken from a video of impact simulation showing the calculated velocity, head orientation and peak force calculation as determined by an embodiment of the inventive system.

FIG. 7 is a simulated image of an impact alert displayed on a smart watch according to an embodiment of the invention.

### DETAILED DESCRIPTION OF EMBODIMENTS

To address the limitations of wearable sensor technologies, the inventive system, dubbed the “Safecyte™ System”, is a novel computer vision-based platform coupled with modern machine learning technology to rapidly acquire visual data, calculate the force exerted against the head, and alert necessary personal. The inventive system combines state-of-art camera technology with machine learning technology, e.g., neural networks, which can be trained to detect and monitor facial features and head motion. Concussion detection approaches for athletes falls into two categories: (1) clinical evaluation using questionnaires, motor tasks, and/or imaging (e.g., MRI, EEG) that can occur quickly on the sidelines or in a clinical setting upon preliminary determination that a concussive event may have occurred, and (2) active monitoring of head impacts that measure the actual force in real time or near-real time, allowing for more objective and accurate detection of a potential concussion to reduce the risk of delayed or no treatment. To overcome the limitation of existing concussion detection methods, the inventive system employs a computer vision/machine learning platform, a high frame rate, high resolution video analysis using proprietary neural networks to track and detect head movements in each frame, and calculating velocity, acceleration, and force of all head impact (potential concussive and sub-concussive injuries). To date, the evaluation system has been used to collect and analyze several hours of real-world and laboratory footage. The computer vision strategy is versatile through the use of novel algorithms to detect and track motion of the head through the identification of two or more key features on the subject's head. This approach is versatile and customizable and may be used with any number of cameras for all sports, whether or not the subject is wearing headgear.

Hardware Components:

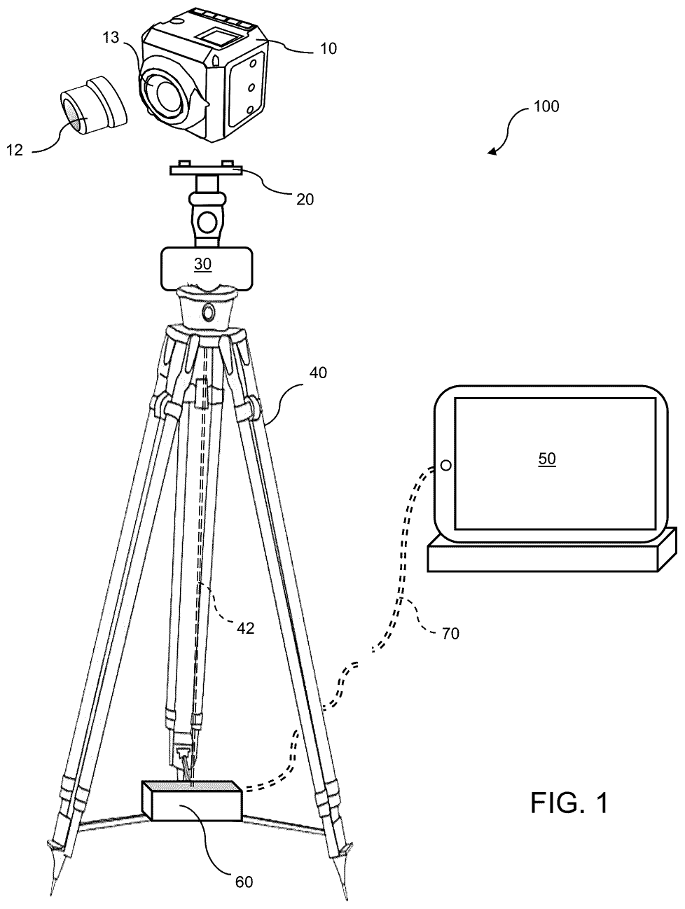

Referring to FIG. 1, an exemplary camera system 100 for performing the inventive method includes five primary components: a high-resolution camera 10, a mounting system 20, a control module 30, camera platform 40, and a user interface/computing module 50. The camera platform 40 may take a number of different forms, as are known in the art. In FIG. 1, the camera platform 40 shown is a conventional tripod. A monopod or similar convention camera support may be used. Examples of options that can be used as a camera platform include a slider or jib arm, a robotic arm, a ground-based vehicle, or a combination of multiple supports, e.g., a robotic arm on a robotic vehicle. In some embodiments, the camera may be mounted on a mobile support, including a drone or other aerial vehicle, or suspended on cables. Additional options include a wall mount or other camera support. In some application, the video may be obtained from previously-positioned surveillance (security) cameras, assuming the cameras have sufficient resolution, or the resolution can be sufficiently enhanced via software.

Positioned nearby, incorporated into, or attached to the camera platform 40 is a power supply 60, such as a battery pack, AC/DC converter module, generator, or other power source. In some embodiments, the power supply may be positioned to provide a low center of gravity and counterbalance to the camera and lens. The power supply 60 may be retained within a base, which, combined with a shaft/pole, which may include telescoping capability. In another implementation, the power supply can be incorporated into a monopod at its lower end for low center of gravity.

Connector cable 42 between the power supply 40 and the control module 30 may be enclosed within the hollow center of a tripod, as shown, or may be exterior to the shaft, preferably with appropriate stabilization via cable ties or other cable control to ensure centering of any objects that might impact on the assembly's balance or present a risk of inadvertent contact. Bundled with connector cable 42 can be a wired connection path, providing either direct point-to-point or connection via a Local Area Network, a Wide Area Network, or other wired connected to an external controller, e.g., user interface/computing module 50. Alternatively, a wireless connection, e.g., WiFi, 5G mobile, may be used. In some embodiments, a Gigabit Ethernet (GigE) cable is used.

In most implementations, multiple cameras would be preferred, however, with improvements neural architecture and artificial intelligence, a single camera may be used. In an exemplary embodiment, camera 10 may be a commercially available high-resolution camera such as those in the Z CAM product line of compact high-resolution cinema cameras (Z Cam, Shenzhen, China). As will be apparent to those in the art, other cameras may be used in the inventive system including commercially-available cameras such as the Blackmagic Pocket Cinema Camera (BMPCC), Komodo, GoPro©, Panasonic BGH1, and more. The camera may include a mounting for interchangeable lenses 12 (e.g., zoom, telephoto, wide angle or fisheye) as well as electronics and motors for control of lens focus and zoom. Exemplary cameras include ports for interfacing via multiple connection protocols, including HDMI (video output), Gigabit Ethernet (camera control, setting and live streaming), USB (camera control and data transformation), XLR audio-in/out, 3.5 mm audio in/out, COM, RS232, remote, WiFi antenna, I/O, and more. For wireless communication, bandwidth capability should be a minimum 1-3 gigabits/sec, and preferably 10 gbits/sec or faster, i.e., 5G or higher. These examples are not intended to be limiting and it will be apparent to those in the art that other connector types and protocols may be selected to match the specifications of different camera manufacturers.

In the prototype system set up to test the inventive method, cameras were selected to produce a continuous stream of high frame rate (>120 fps) and high resolution (>720p HD) data and transmit that data over a high speed network with corresponding bandwidth (>1 Gbit/sec) and long distances (>50 feet) capabilities. Based on the commercially available cameras in 2019, the Oryx 10, from FLIR Systems, Inc., was selected based on cost, third party integration flexibility, customer service, and the fact it supports a GigE network interface.

GigE is a network protocol suitable for the intended application and budget compared to other data connections (USB 3.0, CamerLink, CoaXPress). The GigE connection allows for cable length up to 100 m (and up to 10 kilometers using fiber optics), high bandwidth (>1 GB/s), plug and play solution, low cost commercially available CAT 6e cables, integration with 3rd party software, low CPU load (<5%), and low latency (5-50 microseconds).

A custom computer was constructed for video capture with a NVIDIA 2080 GTX graphic card (GPU), 64 GB memory, 4×10 GigE ports, and 3×1 TB NVMe M.2 solid arranged to RAID 0.

Current algorithms automatically acquire intrinsic camera properties to calibrate code for head localization. As a result, it is not necessary to rewrite code for updates to the camera (software or lens attachment) or complete replacement with newer cameras occurs in the future.

Camera tripods were selected to allow for height flexibility at different facilities. Initial evaluation was conducted using boxing/MMA/wrestling as the easiest to control for weather and the fewest participants to reduce potential obstruction and minimize the number of cameras needed to cover the designated area and maximize visual access for recording the greatest number of impacts per minute of footage.

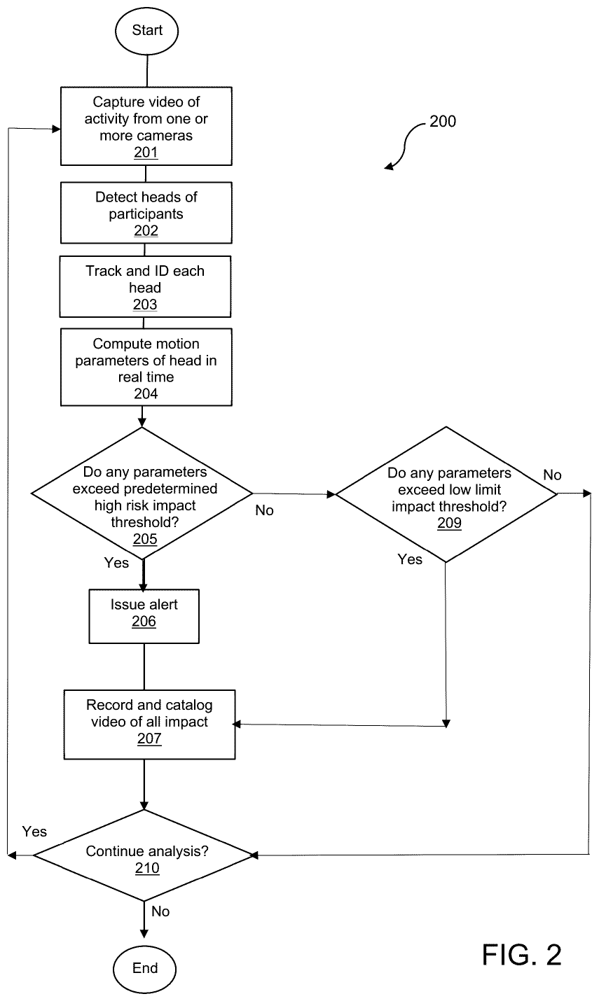

FIG. 2 provides a high level flow diagram of the steps of an exemplary embodiment of the inventive method 200 for impact monitoring on activity participants, e.g., athletes. To start the process, in step 201, a video image, i.e., a sequence of frames, is captured by at least one camera positioned to view the field of play. For purposes of this description, “field of play” can include any area within which a monitored activity occurs and may range from a football field to a boxing ring. It may include a rodeo arena or even a pool in which water polo is played. While a single camera may be used, in many implementations, multiple cameras will be used, distributed, for example, at corners of the field of play. Additional cameras may be placed at mid-field and/or overhead.

Video data will be collected for each athlete or for selected athletes and saved in a uniquely identified record on the system server and/or communicated to a separate server or database. Supporting data to be acquired for each target (athlete or other) to generate a complete record include data can be manually collected, e.g., name, date of birth, sex, weight, along with automatically collected data such as date, time, activity type.

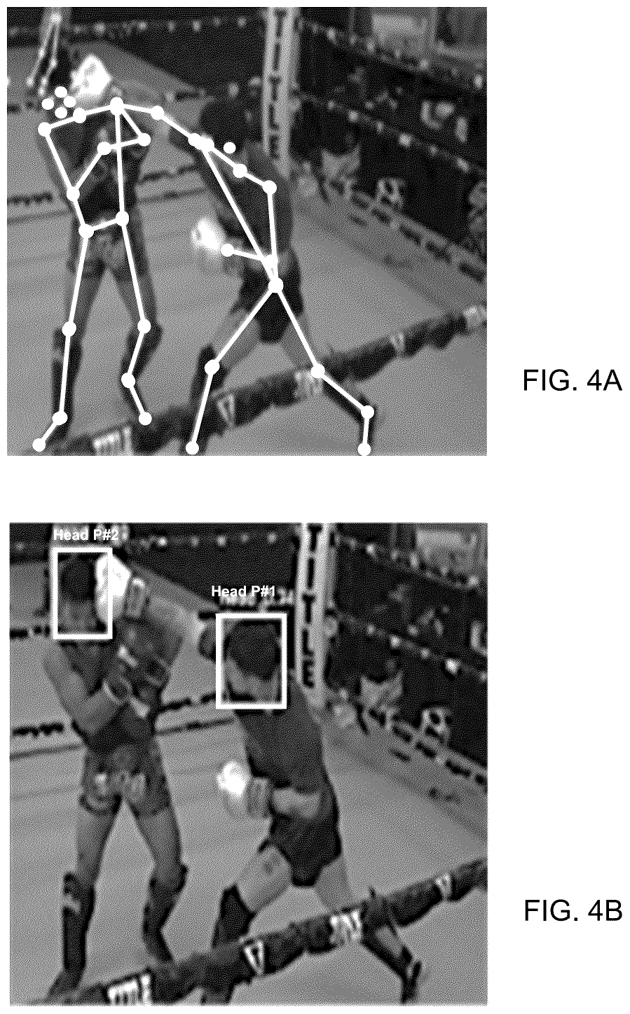

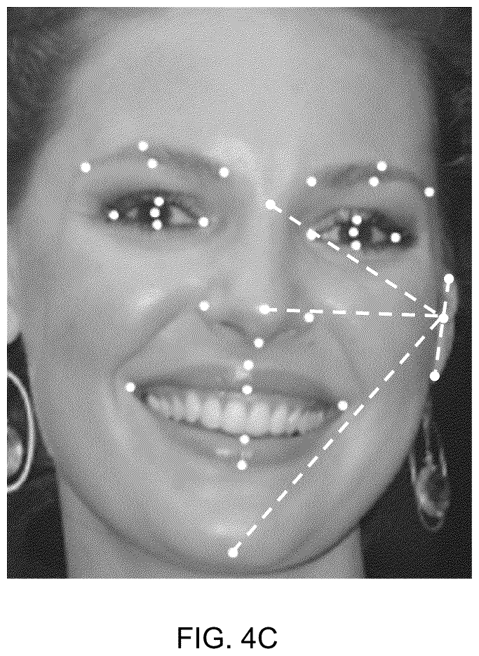

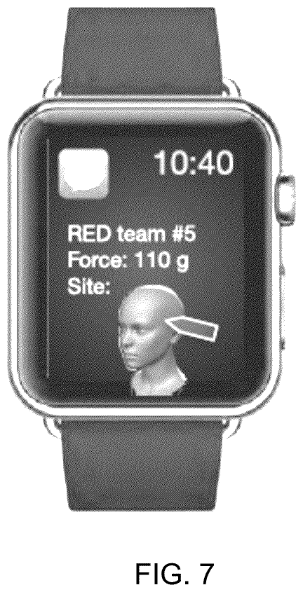

In step 202, within the captured video images, the heads of each of the participants are detected, and in step 203, the detected heads are tracked and associated with a unique identifier. Referring briefly to FIG. 4B, the heads of boxer #1 (P #1) and boxer #2 (P #2) are identified. In step 204, measured parameters are computed to generate values in real time corresponding to motion, velocity, and acceleration for each participate, as will be described further. In step 205, these values are compared against thresholds established as corresponding to the force levels associated with a high risk impact. If the calculated value(s) exceed the predetermined thresholds, the computer issues an alert to a coach, trainer or medical professional (generically, a “supervisor”) indicating that the identified athlete has experienced a high risk impact, allowing the supervisor to take appropriate action, possibly calling for time or, depending on the activity, sending in a substitute for the affected athlete. FIG. 7 provides one example of an alert message that can be displayed on a smart watch or similar device, with the identity of the player (RED team #5), the calculated force (110 g), and an arrow indicating the location on the head where the impact was detected. Similar displays may be generated on a tablet, smart phone, a computer monitor, or other visual interface.

Whether or not a high risk impact is flagged, the system computer will record and catalog the images in step 207. In some implementations, the frame or frames of video in which the impact has been detected may be annotated with measured values, time markers, and other participant data, for review. As the activity continues, the system continues monitoring the participants in step 210 until stopped. If no high risk impact is detected in step 205, the system will further evaluate the calculated values in step 209 to determine whether they exceed a low limit impact threshold. Such data can be useful for evaluation of cumulative impact on a participant. Studies have shown that repeated mild traumatic brain injury (rMTBI) may cause cumulative damage to the brain, which could ultimately result in memory and learning dysfunction. The results of this evaluation are also recorded and cataloged in step 207, with the data stored in a database or memory medium in communication with the computer processor. Alternatively, or in parallel, the video images, collected data and calculations may be transmitted to the cloud for storage for ease of access. Use of cloud storage provides the added advantage of providing access to many users, which may include health-care professionals.

Environmental conditions may also play a role in injuries and may be useful to record. For example, temperature, precipitation, humidity, wind, windchill, etc. The stored record will further include computed data, including force (linear and rotational), accelerations and information about how the images were generated, e.g., steps taken for approach (facial recognition, orientation), and preliminary data relating to camera set-up and adjustment.

The inclusion of a database within the inventive system allows generation of historical records that can be sorted and filtered for patterns that may be associated with increases in injuries, including tracking of individual participants, activity types, environmental conditions, etc. An algorithm can be applied, and the neural network trained, to identify determinative features from such studies to facilitate prediction of risk.

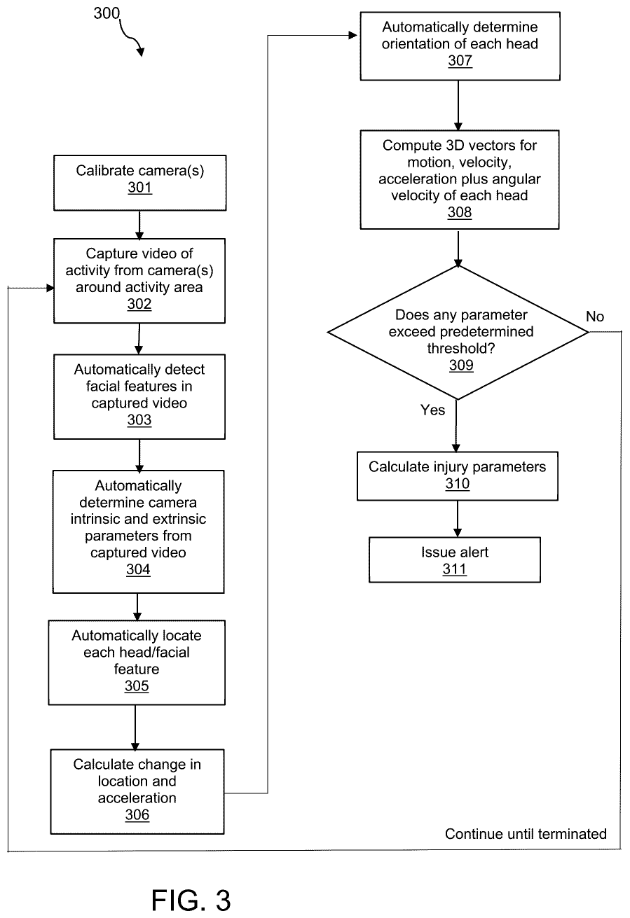

FIG. 3 provides a flow diagram for an exemplary sequence 300 for processing of the video data. In step 301, the camera(s) may be calibrated using techniques known in the art to ensure proper detection capability, contrast, brightness, sharpness, etc. As a non-limiting example, checkerboard calibration targets are widely used in the calibration of machine vision cameras to detect image distortion or sensor issues to ensure measurement accuracy.

In step 302, the camera(s) is/are activation to capture video within the field of play. Using machine learning methods described in more detail below, facial features are automatically detected within the captured video in step 303. In step 304, the system automatically determines intrinsic and extrinsic parameters for the camera(s) from the captured video. The system computer automatically locates each head and facial feature for each participant in step 305, associating unique identifiers with each participant. In subsequent frames within the video sequence, the change in location and acceleration is calculated for each participant (step 306), and the orientation of each head is automatically determined (step 307). Using the location, acceleration and orientation measurements, three-dimensional vectors are determined for motion, velocity, acceleration and angular acceleration are computed for the head of each participant in step 308. In step 309, the values computed for each parameter (vector) are compared against a predetermined threshold corresponding to impact risk. If the threshold is exceeded, injury parameters are calculated in step 310. For example, the level of injury risk may be determined from the ranges of the parameters, or if some, but not all parameters exceeded the thresholds. If the result of this calculation determines that there was a high risk impact, an alert is issued in step 311. If no threshold is exceeded in step 309, video continues to be captured and analyzed until terminated.

The following examples provide descriptions of an exemplary test set-up and simulation of the inventive scheme.

### Example 1: Head Tracking Software

The inventive system uses a nonintrusive head tracking software that accurately calculates 3D Cartesian coordinates using image-feature detection and tracking across multiple cameras.

To gain essential insight into the deep learning capabilities to calculate the location of the head, a large online dataset (YOLO v3 Neural Network) and computer vision techniques were used to correlate tracked features across multiple views. YOLO (You Only Look Once) is a well-known real-time object detection algorithm the employs a convolutional neural network (CNN) that requires only one forward propagation pass through the neural network to make predictions.

A preliminary study testing several different neural networks (e.g., YOLO, wrnch) was performed using subjects who were walking, running, and jumping to evaluate the effectiveness of publicly available neural network databases. Preliminary validation studies were performed at the University of Southern California using 3 cameras tracking a crash dummy after an impact using a pneumatic piston. The results yielded a 7.8% error compared to the crash dummy DTS force sensor, which is considered to be the gold standard. The NOCSEA headform was used, which is the standard for collegiate helmet and mouthguard testing.

Precisely positioned, synchronized, and high frame rate (>120 frames per second) cameras are connected through a 10 GigE interface to a custom consumer-grade computer to process the data using the novel algorithms.

Video Acquisition: A three-camera prototype arrangement was connected to an on-site computer to capture high resolution images up to 308 frames per second. To obtain the desired real-time response, the camera and computer parameters preferably meet the following characteristics:
Camera Frame rate: 120 frames per second (fps) min, preferably 180 fps, more preferably, >200 fps and most preferably, 300 fps. It should be noted that for slower activities, a lower frame rate can be used. Also, with advancements in artificial intelligence (AI), interpolation can be used to calculate magnitude and direction between frames obtained at lower rates.
Camera Resolution: HD quality (above 720 p).
Computer ports: 4-10 GigE ports, possibly expandable to 8.
Operating system: Windows® 10 (64 bit).
Sync requirements for multiple exposures: 10's of microseconds to accommodate high frame rate and shutter speed,
Optics: 8.5 mm HP series lens, ⅔ sensor.
Lens: either fixed or dynamic.
Cable length: ˜45 m to 100 m or more.
Image Depth: 8 bit.
Number of cameras per PC: 2-12

While popular camera brands like GoPro®, Sony®, and smartphones may not currently have the capability to transmit >1 Gbps over long distances, as the technology advances and high quality cameras become available at lower cost, it is anticipated that cameras with suitable transmission rates will, in the not-too-distant future, be available for use with common consumer electronic devices.

### Example 2: Head Identification and Tracking with Modified Neural Network

In the prototype system, online data sets were used to train the initial neural network. Most of these datasets contain images with faces without distortion or obstructions. A subset of 500 real-world images is selected to create a training data subset. FIG. 4A provides an example of a photographic image, i.e., a single video frame, in which each martial arts boxer is superimposed with a stick figure. Heads within the images are manually segmented frame by frame from various points of view. These segmented images form the training dataset that is input into a deep learning algorithm (YOLOv3 in Python) for automatic head tracking. Referring to FIG. 4B, a tight bounding rectangle is located around the head on each image frame and assigned an identifier, e.g., Head P #1. Where multiple cameras are used, the same athlete will be similarly identified within the video sequences captured by each camera.

The camera heights and angles should be positioned to ensure that the calculated force is the same across all cameras. The optimal height may be determined to facilitate faster computation. Additional considerations include training of the neural network on distorted or squished faces, partially obstructed faces, and/or views from the back of the head and with or without hair.

Applications in computer vision and computational photography for detecting human faces in images are well known in the art. For example, the software incorporated in the cameras of most smart phones includes face detection functions for face detection-based autofocus and white balancing in cameras, smile and blink detection. Such applications may include methods for sorting and retrieving images in digital photo management software, obscuration of facial identity in digital photos, facial expression recognition, facial performance capture, avatars, controls, image editing software tailored for faces, and systems for automatic face recognition and verification.

The first step of any face processing system is the detection of locations in the images where faces are present. However, face detection from a single image is challenging because of variability in scale, location, orientation, and pose. Facial expression, occlusion, and lighting conditions also change the overall appearance of faces. The challenges associated with face detection can be attributed to factors including:
(1) Pose: The images of a face vary due to the relative camera-face pose (frontal, 45 degree, profile, upside-down), and some facial features such as an eye or the nose may become partially or wholly occluded.
(2) Presence or absence of structural components: Facial features such as beards, moustaches, and glasses may or may not be present, and there is a great deal of variability among these components including shape, color, and size.
(3) Facial expression: The appearance of faces is directly affected by a person's facial expression.
(4) Occlusion: Faces may be partially occluded by other objects. In an image with a group of people, some faces may partially occlude other faces.
(5) Image orientation: Face images vary directly for different rotations about the camera's optical axis.
(6) Imaging conditions: When the image is formed, factors such as lighting (spectra, source distribution and intensity) and camera characteristics (sensor response, lenses, filters) affect the appearance of a face.
(7) Camera Settings: The settings on the camera can affect the image focus blur, motion blur, depth of field, compression (e.g., jpeg) artifacts, and image noise.

FIG. 4C is a sample image of a person's face with various facial and head features highlighted with a fiducial marker, corresponding to white dots. Such markers are commonly used in facial recognition systems that are intended to provide an identification of the individual based on the combined characteristics of the facial features. According to the inventive scheme, the level of detail used for face recognition is not necessary. Instead, the goal of the inventive method is to recognize changes in the relative locations (distance and angle) and acceleration of features within the head (or body) of the subject over the observation duration. For example, the dashed lines between the subject's ear and nose, chin or nose bridge, or a line from the top to the bottom of the ear, can serve as reference features for measuring relative changes in position with time, and the rates of change, which are then used to calculate force and acceleration to which the subject's head has been subjected. It should be noted that the sample image and the fiducials and reference lines represent one possible approach for head tracking and is not intended to be limiting. It will be readily apparent to those in the art that other approaches for tracking the head may be employed.

Face detection applications based on convolutional neural networks have been reported that are capable of overcoming these many challenges. YOLO is a popular algorithm for face detection due to its speed and accuracy. It is faster than other algorithms due to its simple architecture. Examples, YOLO5Face (Qi, et al, “YOLO5Face: Why Reinventive a Face Detector”, arXiv:2105.1293v2 [cs.CV] 2 Dec. 2021) and YOLO-face (Chen, et al, “YOLO-face: a real-time face detector”, The Visual Computer, Volume 37, pages 805-813 (2021)0, which are incorporated herein by reference.

Given the widely-recognized capability of CNNs, generally, and YOLO, specifically, for effective face detection, further details of the algorithm and training will not be described herein. Furthermore, because the inventive method is not concerned specifically with facial recognition, but only at identification of features that can be used as reference points for detecting changes in position (location, orientation) over time and the rate of those changes (force and acceleration), further details of the learning algorithm are deemed unnecessary for understanding of the invention.

### Example 3: Force Analysis Using Multiple Cameras

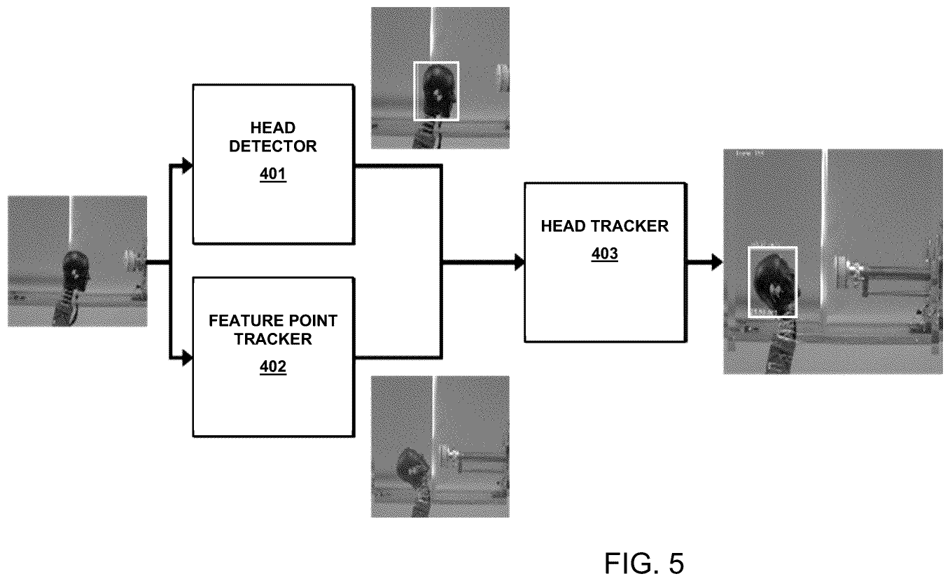

Using the head location in each frame so as to model and compute parameters of the impact, the velocity of each head is tracked in 3-dimensional space and used to determine the change in velocity for each head. Referring to FIG. 5, three basic computing modules within software in in the are used in the head tracking. The video image from each camera is input into head detection module 401 and feature point tracker module 402 to extract the relevant parameters within each frame of the video. The parameters extracted by the feature point tracker module 402 are used to calculate the changes in location and orientation of the relevant features from one frame to the next. The head tracker module 403 combines the results of the head detection and feature tracking to generate the acceleration and force applied to the head. The result is compared to the predetermined threshold. If a head is measured as experiencing a change in velocity that exceeds a safe threshold, the event will be flagged for risk of a possible concussion and a record of the incident and its parameters are recorded.

The objective is to determine the gravitational force (g-force) exerted on the head. Most concussions deliver 90 to 100 g's to the human body upon impact. The algorithms that obtain the 3D coordinates are used to calculate head velocity, acceleration, and angular velocity. The goal of the inventive approach is to replace the need for accelerometers in wearable impact sensors and subjective spotters on the field as are currently used to determine potential concussions. This goal is achieved through the use of neural network training and accuracy of head tracking. Filtering/smoothing of data may be used to calculate g-forces. Such techniques may be augmented through the use of AI methods as are known in the art.

### Example 4: Impact Simulations

G-forces exerted on the head are calculated using the coordinates of tracked visual features across multiple cameras. The test set-up included a pneumatic piston and Hybrid III crash dummy (NOCSAE headform). Preliminary studies have shown that this head form is able to be tracked easily using our neural network and it is the gold standard for all headgear testing in the US (nocsae.org).

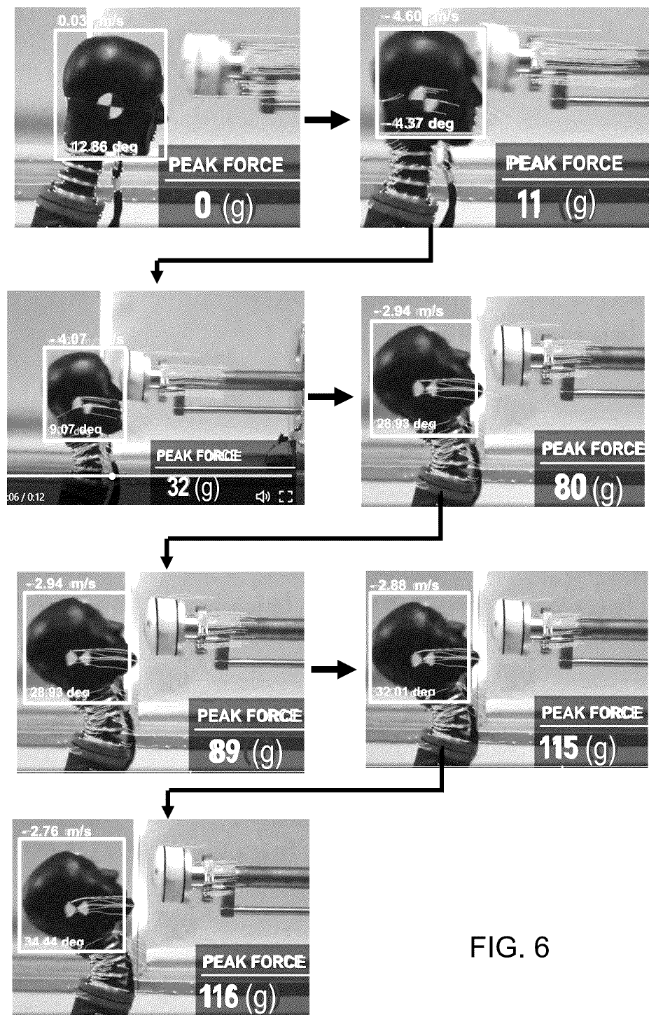

FIG. 6 provides an exemplary sequence of images and resulting measurements obtained using the described test set-up. Each photographic image is a frame extracted from a video sequence, starting with the first frame in the upper left, prior to impact. The value indicated above the white bounding box is the deterred velocity of the head. At the bottom of the bounding box is the measured orientation of the head in degrees relative to a vertical axis. Note that the reference axis may also be established relative to a premeasured “normal” for the subject, however, this would require pre-activity measurement. Since the goal is to measure change as opposed to absolutes, a simple common reference axis for all subjects would be more practical to implement.

At the lower right corner of each image is the peak force applied by the piston. At initial impact, with a peak force of 11 g's, the head's velocity is reversed to −4.60 m/s, while the head orientation is changed to −4.37° relative to vertical. In the third frame, with peak force at 32 g, the velocity is measured as −4.07 m/s, which the head at a 9.070 angle. At peak force of 80 g, the subject's neck is bend further backward, with the head angle increasing to 28.93°. The additional frames show the effects of increased force.

The algorithm-based results should be validated against industry standard thresholds. Accuracy goals should be targeted to achieve within ˜3% of industry-accepted standards. It may be appropriate to make some software adjustments may be made to achieve this goal reliably. Concussion accuracy is crucially important for athlete safety and customer satisfaction.

The inventive noninvasive head impact monitoring scheme aims to overcome the limitations of wearable sensors, and to provide accurate and validated tracking of the head location and orientation. The knowledge gained is the monitoring system will yield novel insights into repeated head impacts and long-term brain damage. The multi-camera component of the inventive system will provide a valuable resource for the scientific community and athletes and supply better protection for all athletes in high-risk activities. While the examples described herein focus on head impact, the same principles may be applied to overall body impacts, e.g., using wire-frame modelling or other full-body representations.

An important goal of the inventive system and method is to provide the ability to evaluate every participant in an activity who may be at risk of concussion injury in near real-time, regardless of socioeconomic status. The inventive approach allows rapid response to avoid further injury during the event as well as reducing the risk of long term effects from delayed response. A wide array of activities can be monitored using the approach, including, but not limited to football, soccer, wrestling, basketball, la crosse, rugby, cheerleading, obstacle courses, and military training. Additional applications may include brain modeling and other medical evaluations.

The principles employed for monitoring and evaluation of impact on the human head or body can be employed in other non-human activities with appropriate modifications. For example, horses can be monitored during polo, horse racing, rodeos. or equestrian events.

Impact on inanimate objects can also be evaluated using the above-described techniques by identifying monitoring points or regions of the objects that are subject to impacts. Accordingly, while the foregoing examples focus on impacts to the human body, with particular emphasis on detection and evaluation of concussion, it will be apparent to a person of skill in the art that the system and method disclosed herein would be useful in other fields and may be applied to the general purpose of evaluating impact and its effect on any object, whether it is a living body or some other body, i.e., an inanimate object

1. A system for monitoring physical impact on a body, the system comprising:
at least one camera configured to collect video images comprising a plurality of image frames of the body within a defined area, the video images comprising a sequence of high resolution data at a high frame rate;
a computer processor configured to receive the video images and execute a learning algorithm for tracking one or more points of the body and calculate a force applied to the one or more points; and
a high-speed interface configured to communicate the video images to the computer processor.

2. The system of claim 1, wherein the body is a human body and the one or more points are associated with a head.

3. The system of claim 1, wherein the defined area is field of play.

4. The system of claim 3, wherein the at least one camera comprises a plurality of cameras, each camera positioned to at least partially surround the field of play.

5. The system of claim 1, wherein the high frame rate is on the order of 120 fps or more.

6. The system of claim 1, wherein the high-speed interface is a 10 GigE or faster interface.

7. The system of claim 1, wherein the learning algorithm is a convolutional neural network.

8. (canceled)

9. The system of claim 1, wherein the computer processor is further configured to generate an alert message to a user interface when the calculated force exceeds a predetermined threshold corresponding to one or more of a high risk impact and a low limit impact threshold.

10-11. (canceled)

12. The system of claim 1, further comprising a memory in communication with the computer processor for recording and cataloging video images and impact data corresponding thereto.

13. A method for monitoring physical impact on a body, the system comprising:
collecting video images comprising a plurality of image frames of the body within a defined area, the video images comprising a sequence of high resolution data at a high frame rate;
receiving the video images within a computer processor and executing a learning algorithm for tracking one or more points of the body within the video images;
calculating a force applied to the one or more points; and
comparing the calculated force to a predetermined threshold corresponding to an impact associated with a potential injury risk.

14. The method of claim 13, wherein the body is a human body and the one or more points are associated with a head.

15. The method of claim 13, wherein the defined area is a field of play.

16. The method of claim 15, wherein the at least one camera comprises a plurality of cameras, each camera positioned to at least partially surround the field of play.

17. The method of claim 13, wherein the high frame rate is on the order of 120 fps or more.

18. The method of claim 13, wherein the high-speed interface is a 10 GigE or faster interface.

19. The method of claim 13, wherein the learning algorithm is a convolutional neural network.

20. (canceled)

21. The method of claim 13, wherein the computer processor is further configured to generate an alert message to a user interface when the calculated force exceeds the predetermined threshold corresponding to one or more of a high risk impact and a low limit impact threshold.

22-23. (canceled)

24. The method of claim 13, further comprising recording and cataloging video images and impact data corresponding thereto in a memory in communication with the computer processor.
